(19) United States
(12) Patent Application Publication
(10) Pub. No.: US 2007/0256278 A1
(43) Pub. Date: Nov. 8, 2007

(54) HAND TOOL

(76) Inventors: ANDRE FORTIER, Berthier-Sur-Mer (CA); Patrick Julien, Levis (CA)

Correspondence Address: GOUDREAU GAGE DUBUC, 2000 MCGILL COLLEGE, SUITE 2200, MONTREAL, QC, H3A 3H3, US

(21) Appl. No.: 11/737,841

(22) Filed: Apr. 20, 2007

(30) Foreign Application Priority Data
Apr. 21, 2006 (CA) 2,544,455

(51) Int. Cl. B25G 1/10

(52) U.S. Cl. 16/430

(57) ABSTRACT

A hand tool and a method of fabrication thereof, the tool comprising a head having a neck portion provided with perforations, and a handle comprising a core and a sleeve, the sleeve of the handle being molded over the core and the neck, the material of the sleeve forming a bridge between the core and the neck and filling the perforations of the neck.

### CROSS REFERENCE TO RELATED APPLICATIONS

This application claims priority on Canadian application no. CA 2,544,455, filed on Apr. 21, 2006. All documents above are herein incorporated by reference.

### FIELD OF THE INVENTION

The present invention relates to hand tools.

### SUMMARY

There is provided a tool, comprising a head having a neck portion provided with perforations; and a handle comprising a core and a sleeve, the sleeve of the handle being molded over the core and the neck, a material of the sleeve forming a bridge between the core and the neck and filling the perforations of the neck.

There is further provided a method for mounting a head to a handle to form a hand tool, comprising the steps of providing a head having a neck with perforations; providing a core; positioning the core and the head in a mold for a handle, a free end of the neck being in the continuity of an end of the core; and injecting a material in the mold; the material bridging a separation between the free end of the neck and the end of the core and filling the perforations of the neck and forming a sleeve.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

In the appended drawings:

FIG. 1 is a side view of a tool according to a first embodiment of the present invention;

FIG. 2 is a side view of a tool according to a second embodiment of the present invention;

FIG. 3 is a side view of a tool according to a third embodiment of the present invention;

FIG. 4 is a cut off view of a section of a handle of a tool according to an embodiment of the present invention;

FIG. 5 shows mounting the head and the handle of a tool according to an embodiment of the present invention;

FIG. 6 is a side view of a tool according to a fourth embodiment of the present invention; and

FIGS. 7-11 illustrate a case for a tool according to embodiments of the present invention.

### DESCRIPTION OF EMBODIMENTS OF THE INVENTION

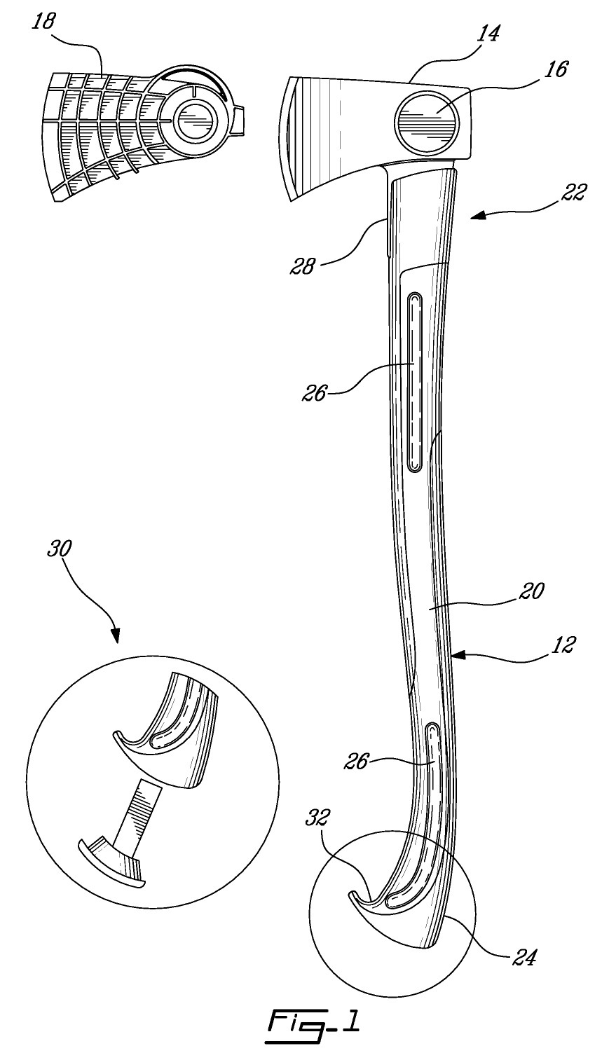

A tool as generally illustrated in FIGS. 1-3 of the appended drawings comprises a handle 12 and a head 14.

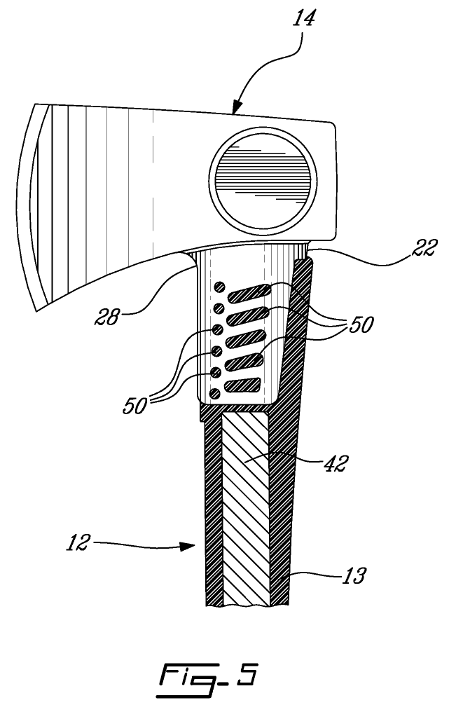

The head 14 comprises a neck 22 provided with perforations 50, as best seen in FIG. 5.

The head 14 is connected to the handle 12 by overmolding the material of the handle 12 over the neck 22, whereby the material of the handle encapsulates the neck 22 and fills the perforations 50 of the neck 22.

The neck 22 may be encapsulated on three sides thereof, leaving a side 28 with the material of the neck, such as steel, for example, apparent to protect the handle 12 from damages from mishaps, i.e, when landing the handle 12 against a workpiece for example.

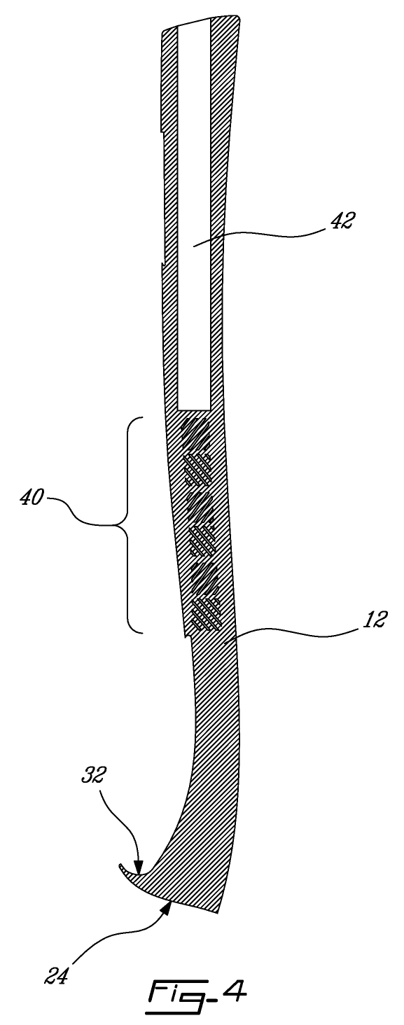

The handle 12 comprises a sleeve 13 and a core 42. The core 42 is encapsulated in the sleeve 13, generally centrally relative to the width of the sleeve 13, over a given length of the sleeve, as shown for example in FIGS. 4 and 5, from an upper end thereof.

The core 42 is encapsulated in the sleeve 13, together with the neck 22 of the head, the core 42 and the neck 22 remaining separated by a thickness of the material of the sleeve 13. This thickness of material is of about 7/32 inches, to avoid deformation of the material of the sleeve 13 at this location upon cooling, and to create a bridge between the upper end of the core 42 and the lower end of the neck 22 for transverse resistance of the handle.

The sleeve 13 is generally made in a composite material, such as nylon reinforced with glass fibers, or charged polyethylene (PE) for example.

The core 42 may be a molded polypropylene rod, or a rod in a lighter, less dense material such as wood fibers or high-density foam, filling the sleeve 13.

The handle 12 may further comprise a coating 20, in thermoplastic rubber for example, extending generally longitudinally from the upper end of the sleeve 13 to a bottom end region of the sleeve 13, in the free end region 24 of the handle 12, on parts of the sleeve 13, on each side thereof. Such coating allows an unimpeded up and down movement of the hand of a user along the handle 12. The coating 20 may comprise relieves 26, for optimizing the grip by the user. Such relieves 26 may further be used as markers for hand positioning.

Variations of sections and of material in the handle 12 may be contemplated to dampen vibration. As shown in a cut off view of FIG. 4 for example, the sleeve 13 may comprise ribbed sections 40, which are filled with the material of the coating 20.

At the free end 24 of the handle, the sleeve 13 may have a curved shape 32 for an enhanced grip and for preventing dropping the tool.

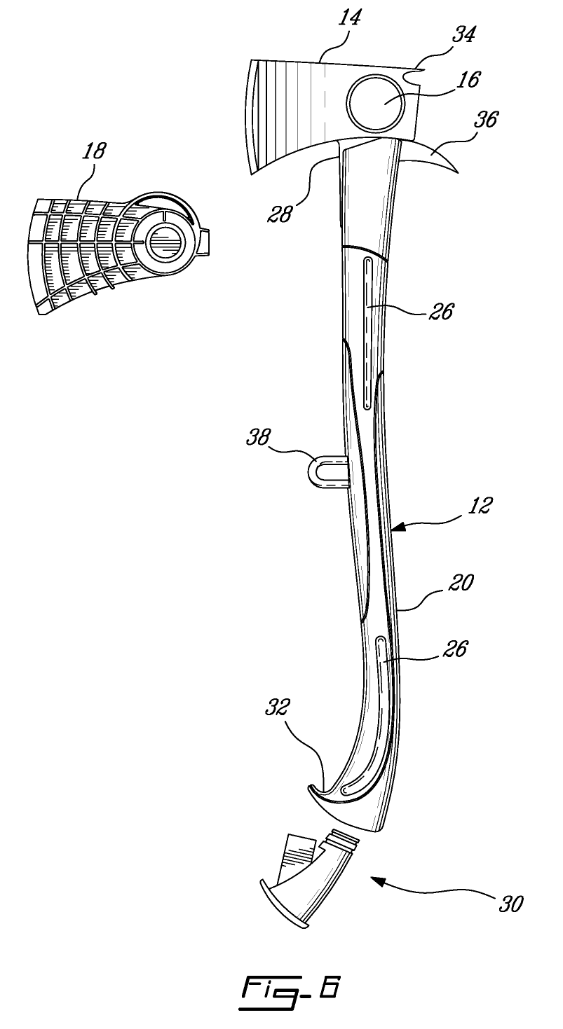

A recess 30 may be accommodated in the sleeve 13 of the handle 12, for securing sharpening files for example, as shown in FIG. 6.

As shown in the embodiment illustrated in FIG. 6, additional implements, such as a tooth 36 or a hook 38 for example, may be provided about the handle 12, in a folding mount, folding into the sleeve of handle 12 in an out-of-use position, and projecting out from the surface of the sleeve when used.

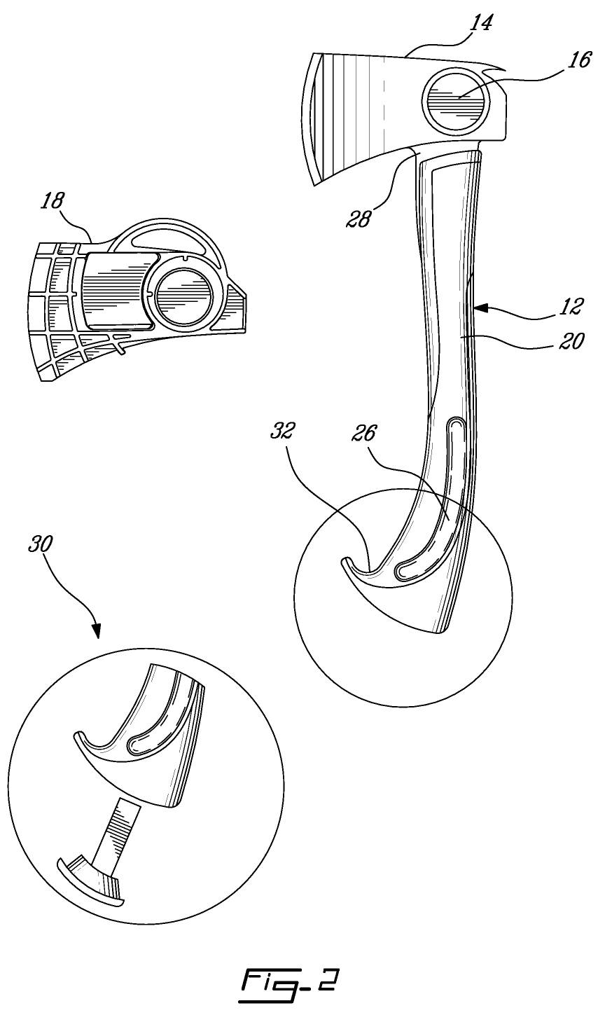

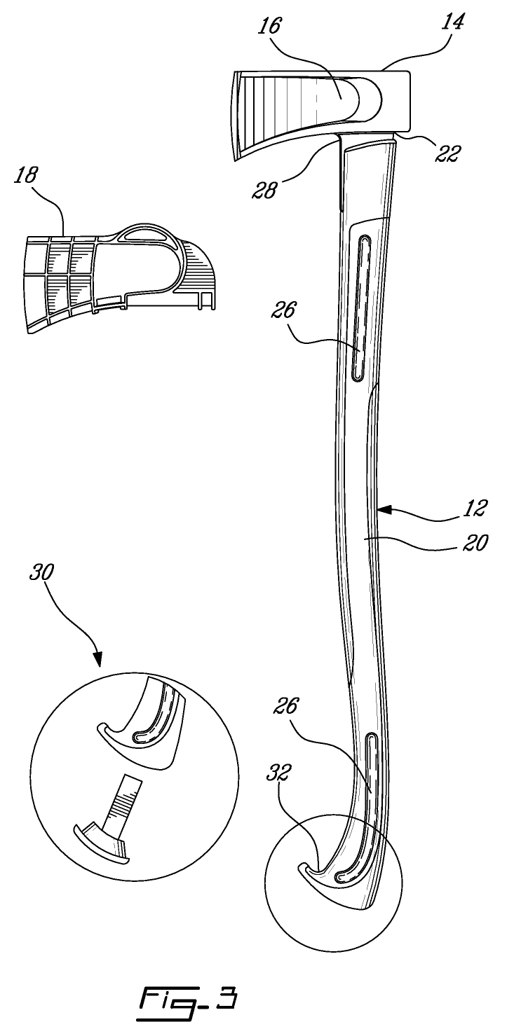

The head 14 may be a blade, in the case of a multipurpose axe (FIG. 1), or of a hatchet (FIG. 2), or of a splitting maul (FIG. 3) for example. Other hand tools may be considered with different types of heads, such as hammers or impact instruments for example.

In the present illustrations, the head is generally a blade, but it could comprise a face and claw in the case of a hammer for example. The head 14 may be provided with a nail puller 34 (see FIG. 6).

The head 14 is generally made of steel.

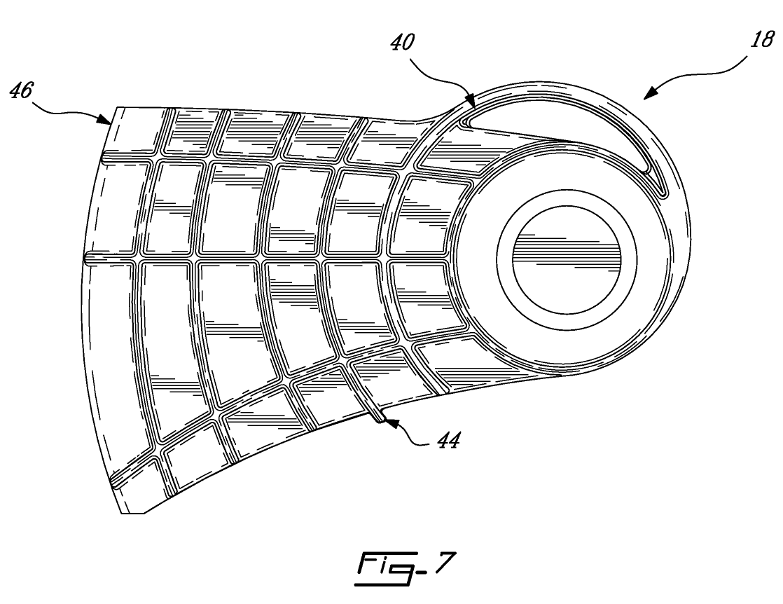

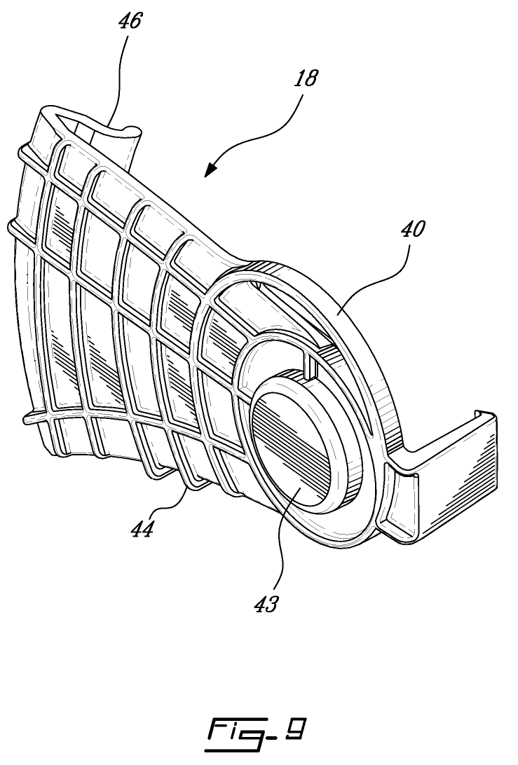

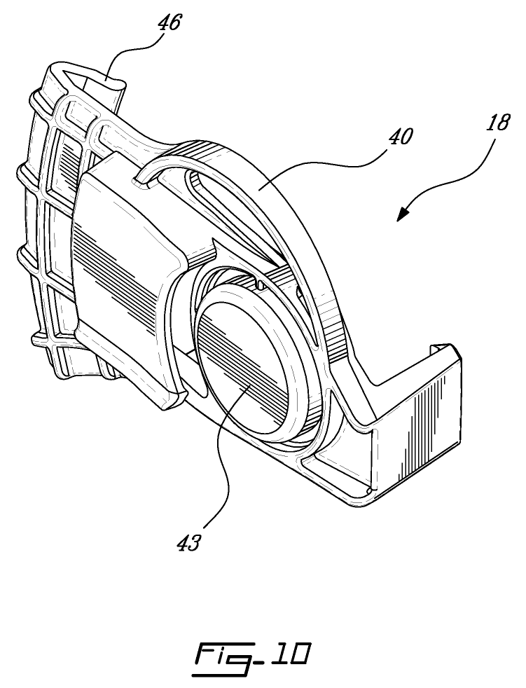

The head 14 includes a region 16, on a face thereof, intended for receiving a magnet element of a case 18, so that, when in place, the case 18 is secured to the head 14, as will be described hereinafter in relation to FIGS. 7 to 11.

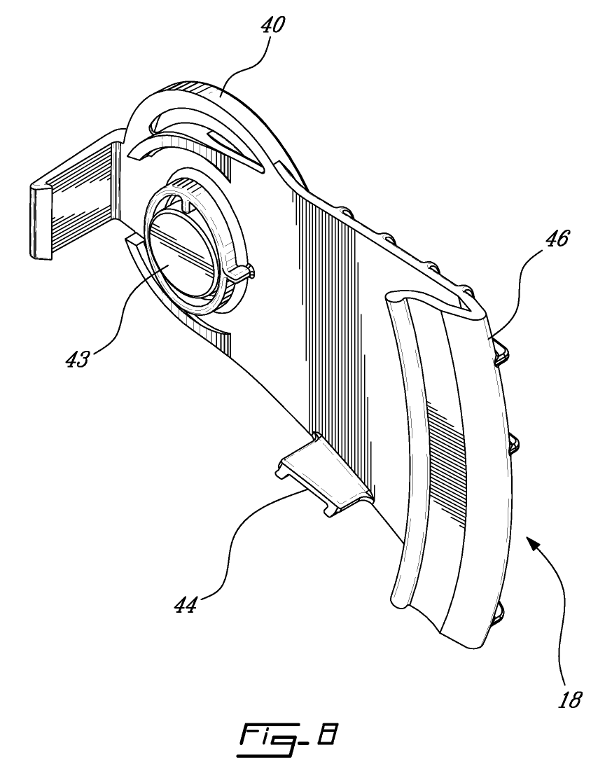

As illustrated in FIGS. 8, 9 and 11, the case 18 is provided with a magnet element 43 on an inner face thereof, which engages the region 16 of the head 14 of the tool, so that, when in place, the case 18, further supported by a tooth 44 for example, is secured to the head 14.

The case 18 may comprise a blade protection feature 46 in a region covering the blade.

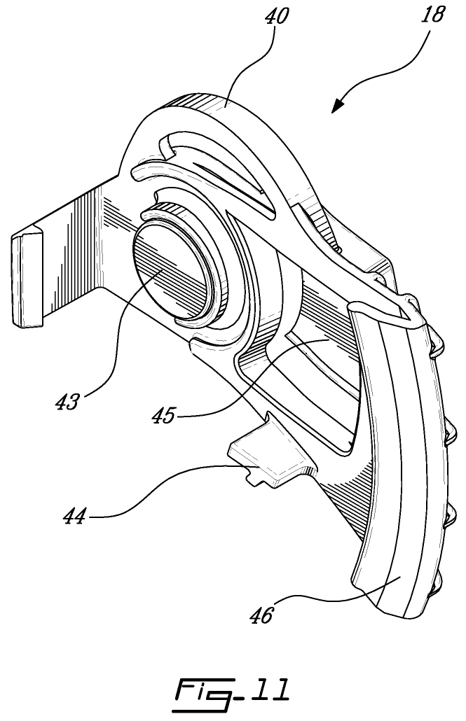

Moreover, the case 18 may be provided with a hook 40, as shown in FIGS. 7 to 10, allowing hanging the tool on a wall for storage purposes for example, and/or a clip 45, as shown in FIG. 11, for fixing to a belt worn by the user for example, for transportation.

A method according to an embodiment of another aspect of the present invention generally comprises positioning a core and a head in an injection mold and injecting a sleeve around the rod and the neck of the head. The core fills the sleeve of the handle, the material of the sleeve joining the neck and the core by forming a bridge between the neck and the core, and penetrating perforations of the neck for stronger junction.

Although the present invention has been described hereinabove by way of embodiments thereof, it may be modified, without departing from the nature and teachings of the subject invention as defined in the appended claims.

1. A tool, comprising:
a head, said head having a neck portion provided with perforations; and
a handle, comprising a core and a sleeve;
wherein said sleeve of the handle is molded over said core and said neck, a material of the sleeve forming a bridge between the core and the neck and filling said perforations of the neck.

2. The tool of claim 1, wherein said material of the sleeve comprises a composite material, and said head made of steel.

3. The tool of claim 1, wherein the material of the sleeve encapsulates said neck on three sides thereof.

4. The tool of claim 1, wherein said core of the handle is a rod encapsulated in the material of the sleeve, at a center of the sleeve, over at least a part of a length of the sleeve from an upper end thereof.

5. The tool of claim 1, wherein said handle further comprises a coating, extending generally longitudinally from an upper end of the sleeve to a free end region of the sleeve, over at least a part of said sleeve.

6. The tool of claim 4, wherein said rod is made of one of: i) polypropylene, ii) wood fibers, and iii) foam.

7. The tool of claim 5, wherein said coating is a thermoplastic material.

8. The tool of claim 5, wherein said coating comprises relieves.

9. The tool of claim 1, wherein said sleeve has a varying section along a length of the handle.

10. The tool of claim 5, wherein said sleeve comprises ribbed sections, said coating filling said ribbed sections.

11. The tool of claim 1, wherein said sleeve has a curved shape at a free end of said handle.

12. The tool of claim 1, wherein said sleeve accommodates at least one recess.

13. The tool of claim 1, wherein said handle further comprises implements foldingly mounted in the sleeve thereof.

14. The tool of claim 1, further comprising a case for the head.

15. The tool of claim 14, wherein said case comprises a magnet element on an inner surface thereof, said magnet element securing the case to the head.

16. The tool of claim 14, wherein said case comprises a hook for hanging the tool, once the case is in place over the head of the tool.

17. A method for mounting a head to a handle to form a hand tool, comprising the steps of:
providing a head having a neck with perforations;
providing a core;
positioning the core and the head in a mold for a handle, a free end of the neck being in the continuity of an end of the core; and
injecting a material in the mold;
whereby the material bridges a separation between the free end of the neck and the end of the core, fills the perforations of the neck and forms a sleeve.

18. The method of claim 17, wherein said step of providing a head comprises providing a head made of steel.

19. The method of claim 17, further comprising providing a coating over at least parts of the sleeve.

20. The method of claim 17, wherein said step of injecting a material in the mold for the handle comprises injecting a composite material.

21. The method of claim 17, wherein said step of injecting a material in the mold for the handle comprises injecting one of: i) nylon reinforced with glass fibers and ii) charged polyethylene.

22. The method of claim 17, wherein said step of providing a core comprises providing a rod.

23. The method of claim 17, wherein said step of providing a core comprises providing a member in one of: i) polypropylene; ii) wood fibers, and iii) high-density foam.

24. The method of claim 17, wherein the mold for the handle provides a hook shape at a free end of the sleeve.

25. The method of claim 17, wherein the mold for the handle provides at least one recess in the sleeve.

26. The method of claim 17, wherein said step of providing a head comprises providing a head including at least one of: i) a blade, ii) a hammer face, iii) an impact face, iv) a nail puller and v) a claw.

27. The method of claim 17, wherein said step of providing a head comprises providing a head including a region, on a face thereof, for receiving a magnet element of a case.
